(19) United States
(12) Patent Application Publication
(10) Pub. No.: US 2012/0053730 A1
(43) Pub. Date: Mar. 1, 2012

(54) THERMAL PRINTER AND CONTROL METHOD THEREOF

(75) Inventor: Takanori Nagatsu, Shizuoka (JP)

(73) Assignee: TOSHIBA TEC KABUSHIKI KAISHA, Tokyo (JP)

(21) Appl. No.: 13/046,964

(22) Filed: Mar. 14, 2011

(30) Foreign Application Priority Data
Aug. 31, 2010 (JP) 2010-194324

(51) Int. Cl. G05B 15/00

(52) U.S. Cl. 700/275

(57) ABSTRACT

Embodiments described herein are to a printer includes a step number counting device which receives drive information associated with a cutter motor, and further counts a step number representing a rotational angle of a rotatable blade which is rotated in conjunction with a drive of the cutter motor. The printer further includes a cut state determining device which determines whether a sheet material is completely cut, based on the counted step number provided from the step number counting unit, and a predefined cut state/step number that represents a relationship between a position where the sheet material is completely cut by the rotatable blade and a corresponding step number. The printer further includes a control device which generates a drive instruction to drive the cutter motor when the cut state determining device determines that the sheet material is completely cut.

### CROSS-REFERENCE TO RELATED APPLICATIONS

This application is based upon and claims the benefit of priority from Japanese Patent Application No. 2010-194324, filed on Aug. 31, 2010, the entire contents of which are incorporated herein by reference.

### FIELD

Embodiments described herein relate generally to a thermal printer and a control method thereof.

### BACKGROUND

In a sheet material cutting device that is provided in a thermal printer used in a point of sale (POS) terminal to issue a receipt, a printed elongated paper (hereinafter, referred to as “a sheet material”) is cut in a transverse direction perpendicular to the feed direction of the sheet material while it is being conveyed. In such a sheet material cutting device, the sheet material is cut by the engagement of a rotary cutting blade (hereinafter, referred to as “a rotatable blade”) with a fixed blade facing the rotatable blade. The rotatable blade includes a blade member provided on the outer periphery of a rotary shaft, the blade member extending from one end to the other end of the rotary shaft at a predefined angle with respect to the axial direction of the rotary shaft. In such a rotatable blade, the outer periphery of the rotary shaft, which is formed in front of the blade member, also functions as a guide member which urges the sheet material toward the fixed blade upon the rotation of the rotary shaft. For this purpose, the outer periphery of the rotary shaft is formed in a circular arc shape along the rotational direction of the rotary shaft.

In a sheet material cutting device with the above-described configuration, the sheet material is cut by rotating the rotatable blade at a constant speed. After the sheet material is cut, the uncut sheet material is fed backwards. During feedback of the uncut sheet material, the rotatable blade is returned to a home position, where the rotatable blade is initially located, at a constant speed even after the cutting operation is completed. In some cases, even after the sheet material has been fed back to a printable position, the rotatable blade may not yet be returned to the home position to initiate cutting the printed sheet material. This may prolong the time required for cutting after printing.

### BRIEF DESCRIPTION OF THE DRAWINGS

FIG. 1 is a perspective view showing an example of a thermal printer according to an illustrative embodiment.

FIG. 2 is a side elevational view of the thermal printer.

FIG. 3 is a block diagram showing a hardware configuration of a thermal printer according to an illustrative embodiment.

FIG. 4 is a block diagram of a thermal printer according to an illustrative embodiment.

FIG. 5 is a side elevational view showing an explanatory configuration of a sheet material cutting device according to an illustrative embodiment.

FIG. 6 is a perspective view showing a rotatable blade of a sheet material cutting device according to an illustrative embodiment.

FIG. 7 is a flow chart explaining an example of a sheet material cutting process in a thermal printer according to an illustrative embodiment.

FIG. 8 is a side elevational view explaining a sheet material cutting process in a thermal printer.

FIG. 9 is a side elevational view explaining a sheet material cutting process in a thermal printer.

FIG. 10 is a side elevational view explaining a sheet material cutting process in a thermal printer.

FIGS. 11A to 11D are side elevational views explaining a sheet material cutting process in a thermal printer according to another embodiment.

FIG. 12 is a block diagram of a thermal printer according to another embodiment.

### DETAILED DESCRIPTION

According to one embodiment, a printer includes a step number counting device configured to receive drive information associated with a cutter motor, and further configured to count a step number representing a rotational angle of a rotatable blade which is rotated in conjunction with a drive of the cutter motor. The printer further includes a cut state determining device configured to determine whether a sheet material is completely cut, based on the counted step number provided from the step number counting device, and a predefined cut state/step number that represents a relationship between a position where the sheet material is completely cut by the rotatable blade and a corresponding step number. The printer further includes a control device configured to generate a drive instruction to drive the cutter motor when the cut state determining device determines that the sheet material is completely cut. The rotatable blade is returned to a home position by the drive of the cutter motor at a rotational speed higher than that of the cutting of the sheet material.

Embodiments will now be described in detail with reference to the drawings.

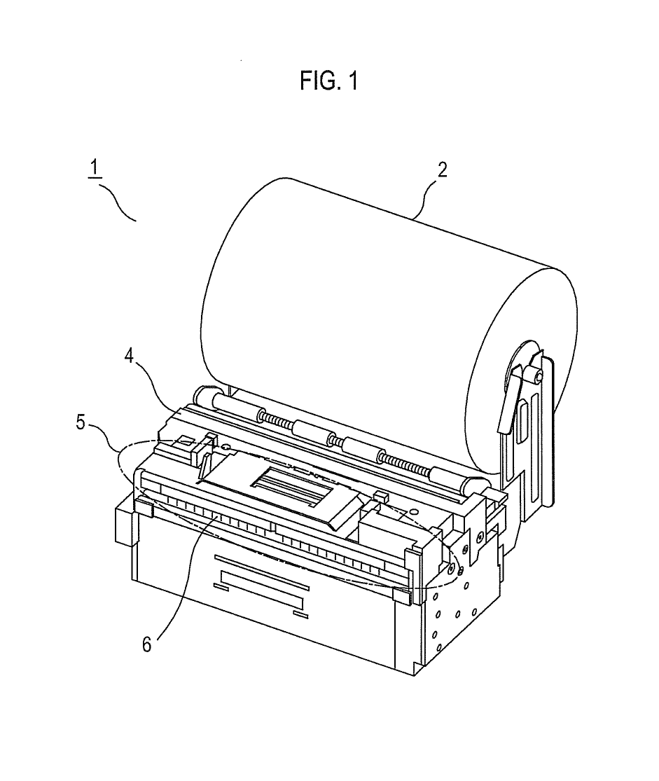

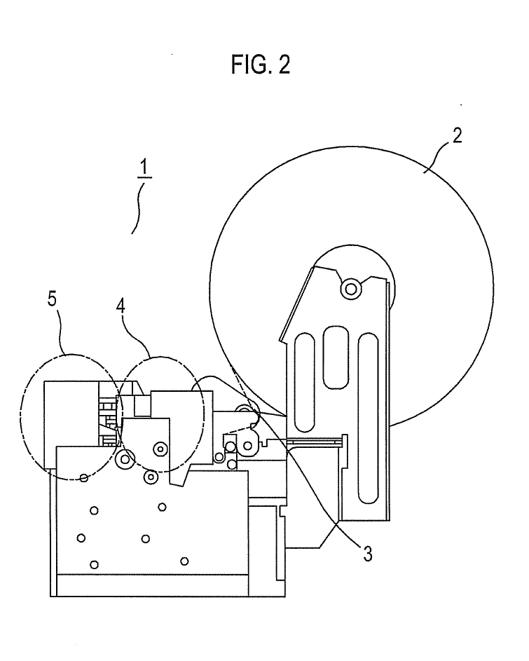

FIG. 1 is a perspective view showing an example of a thermal printer according to an illustrative embodiment. FIG. 2 is a side elevational view of the thermal printer shown in FIG. 1. As shown in FIGS. 1 and 2, a paper roll 2 with an elongated sheet material (e.g., paper) wound thereon is rotatably disposed at a rear portion (i.e., right side of FIG. 2) of a main body of a thermal printer 1. One end of the elongated sheet material 2 is inserted into the main body of the thermal printer 1 from a sheet material supplying unit 3, and is conveyed to a print unit (e.g., a thermal head) 4 in the main body of the thermal printer 1 in a longitudinal direction of elongated sheet material 2 by a conveying mechanism (not shown). The print unit 4 prints certain characters, graphics, or the like on the conveyed sheet material 2. The printed sheet material 2 continues to be conveyed in a longitudinal direction thereof, so that a leading edge of the printed sheet material 2 passes through a sheet material cutting unit 5 positioned in the downstream direction of the print unit 4. Then, the printed sheet material 2 is discharged outside of the thermal printer 1 through an outlet 6 formed at an upper portion of a front side (i.e., left side of FIG. 2) of the main body of the thermal printer 1.

If the leading edge of the sheet material 2 is conveyed by a predetermined distance, the sheet material cutting unit 5 cuts the conveyed sheet material 2 in a transverse direction perpendicular to the feed direction of the sheet material 2, without stopping the conveyance of the sheet material 2. Since the leading edge of the sheet material 2 is already discharged out of the outlet 6 when a predetermined length of the sheet material 2 is cut, the cut sheet material hangs down outside the thermal printer due to its own weight.

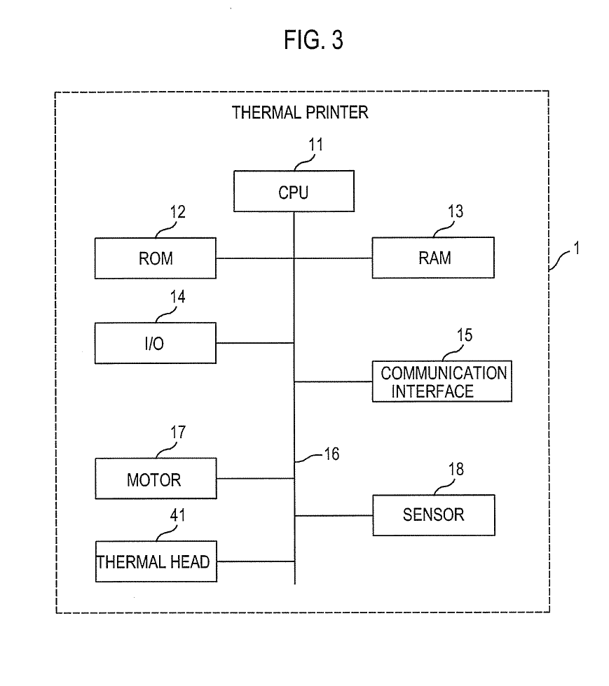

FIG. 3 is a block diagram showing a hardware configuration of the thermal printer 1 according to an illustrative embodiment. As shown in FIG. 3, the thermal printer 1 includes a central processing unit (CPU) 11, a read only memory (ROM) 12, a random access memory (RAM) 13, an input/output (I/O) port 14, and a communication interface (I/F) 15, which are connected with each other through a bus line 16.

The CPU 11 executes various operations based on operation programs or data stored in the ROM 12 and the RAM 13. The ROM 12 is a read-only memory device configured to store therein various basic programs or configuration files to drive a computer. The RAM 13 is a memory device configured to temporarily store programs or data while the CPU 11 executes the operation programs. In some sense, the RAM 13 functions as a work area and is capable of performing read/write operations at a high speed. Further, the data on the RAM 13 may be maintained by a backup battery. The RAM 13 may include a print buffer and a character generator.

Further, the input/output (I/O) port 14 includes an input port to input information to the CPU 11, and an output port to transmit information from the CPU 11 to respective units of the thermal printer 1. The communication I/F 15 is configured to enable communication with an external device (e.g., a higher-level device) through a network. Specifically, the communication I/F 15 is configured to interface reception of required data, for example, reception of printing data (e.g., character codes) representing content to be printed on the sheet material 2 and cutting instruction data transmitted from the external device.

Further, various motors 17 (e.g., a feed motor, a cutter motor, etc.), various sensors 18 (e.g., a paper sensor to detect the running out of a paper, a cover sensor to detect opening/closing of a cover, etc.) and a thermal head 41 are connected to the CPU 11 via the bus line 16. The CPU 11 executes the operation programs stored in the ROM 12 to control respective units provided in the thermal printer 1.

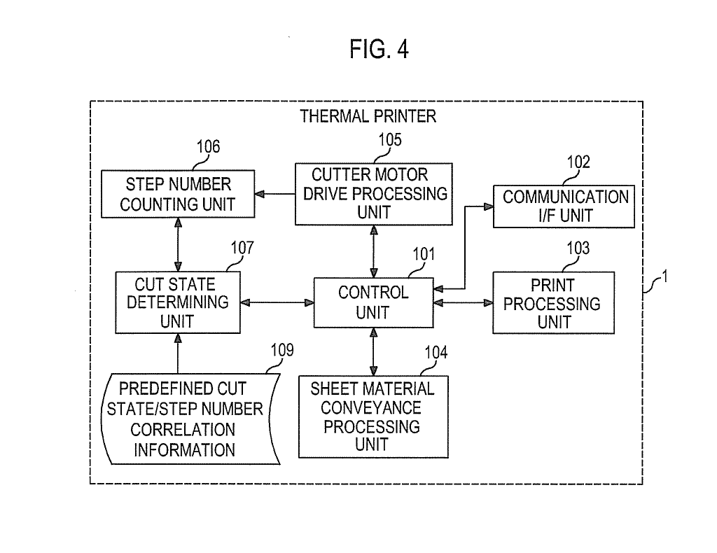

FIG. 4 is a block diagram showing a configuration of the thermal printer 1 shown in FIG. 1. As shown in FIG. 4, the thermal printer 1 includes a control unit 101, a communication I/F unit 102, a print processing unit 103, a sheet material conveyance processing unit 104, a cutter motor drive processing unit 105, a step number counting unit 106, and a cut state determining unit 107.

The control unit 101 is configured to generate and output various control instructions (e.g., a conveyance instruction, a motor drive instruction, a print instruction, etc.) to respective modules, thereby controlling the entire operation of the thermal printer 1.

The communication I/F unit 102 is configured to enable communication with an external device (e.g., a higher-level device) through a network. The communication interface 15 interfaces reception of required data, for example, reception of printing data (e.g., character codes) representing content to be printed on the sheet material 2 and a cutting instruction data transmitted from the higher-level device.

The print processing unit 103 is configured to allow the thermal head 41 to print the printing data provided from the higher-level device on the sheet material 2, in response to the print instruction provided from the control unit 101.

The sheet material conveyance processing unit 104 is configured to drive a conveyance mechanism of the sheet material supplying unit 3 in response to the conveyance instruction provided from the control unit 101 so that the sheet material 2 may be conveyed towards and away from the sheet material cutting unit 5.

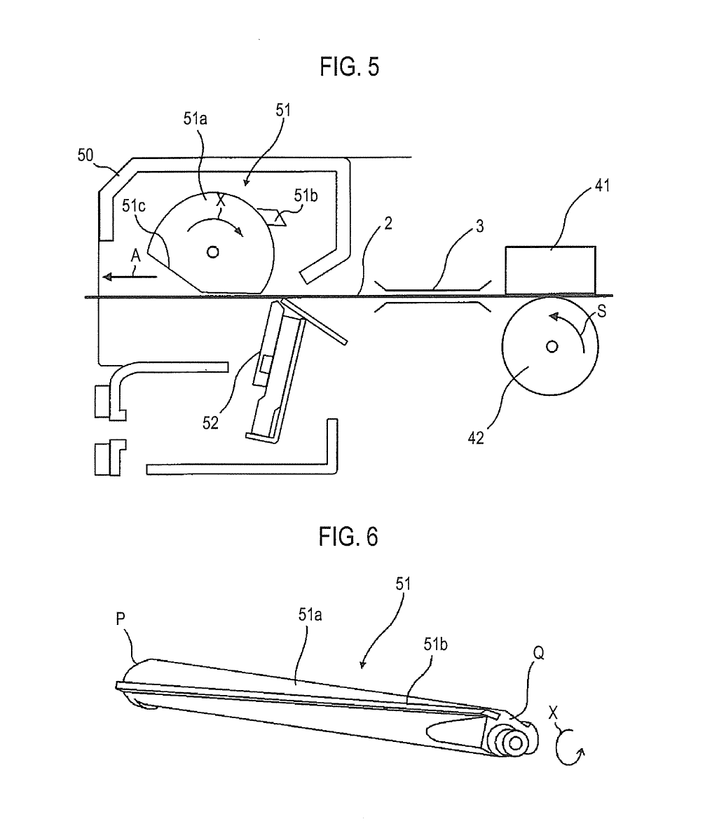

The cutter motor drive processing unit 105 is configured to drive a cutter motor provided in the sheet material cutting unit 5 in response to the drive instruction provided from the control unit 101. In one embodiment, as shown in FIG. 5, the sheet material cutting unit 5 includes a rotary cutting blade (hereinafter, referred to as “a rotatable blade”) 51 and a fixed cutting blade (hereinafter, referred to as “a fixed blade”) 52. The rotary shaft 51a of the rotatable blade 51 is connected with the cutter motor, thereby rotating in conjunction with the rotation of the cutter motor. With this configuration, the sheet material 2 is cut by the engagement of the rotatable blade 51 with the fixed blade 52.

The step number counting unit 106 receives cutter motor drive information provided from the cutter motor drive processing unit 105. Based on the cutter motor drive information, the step number counting unit 106 is configured to count a step number representing a rotational angle of the rotatable blade 51 which rotates in conjunction with the rotation of the cutter motor. The step number counting unit 106 performs a counting of the step number from the beginning of the driving of the cutter motor. The step number counted at the step number counting unit 106 is provided to the cut state determining unit 107.

Based on the counted step number provided from the step number counting unit 106, the cut state determining unit 107 is configured to determine whether the sheet material 2 is completely cut, with reference to a predefined cut state/step number correlation information 109 which represents a relationship between a position of the rotatable blade 51 (when the sheet material 2 is completely cut) and a corresponding step number. The predefined cut state/step number correlation information 109 may be stored in, for example, the ROM 12. The cut state determining unit 107 provides the determination result (e.g., cut completion information indicating that the sheet material 2 is completely cut) to the control unit 101.

The control unit 101, in response to the cut completion information provided from the cut state determining unit 107, outputs a subsequent drive instruction to the cutter motor drive processing unit 105. Then, the cutter motor drive processing unit 105 increases the rotational speed of the cutter motor to move the rotatable blade 51 to a home position. Simultaneously, the control unit 101 outputs the conveyance instruction to the sheet material conveyance processing unit 104, which drives the conveyance mechanism of the sheet material supplying unit 3. Then, the sheet material conveyance processing unit 104 conveys the sheet material 2 so that a new leading edge of the sheet material 2 (i.e., sheet material to be printed yet) is fed back to the thermal head 41.

In one embodiment, a speed of the feedback may be higher than the rotational speed of the rotatable blade 51. For example, it is assumed that a step number (e.g., a pulse number) required for one rotation cycle is 720 steps and a step number required for completely cutting the sheet material 2 is 99 steps. With this assumption, if a time for one rotation of the cutter motor is 1.44 sec, a rotational speed of the rotatable blade 51 of 17 mm diameter during cutting is about 37 mm/sec. Under such condition, for example, the sheet material 2 is fed back at a speed of 127 mm/sec after cutting while the rotatable blade 51 returns to the home position at the same speed (i.e., 37 mm/sec) as used during cutting. In this case, because the speed of the rotatable blade 51 is lower than the feedback speed (i.e., 127 mm/sec), while the rotatable blade 51 returns to the home position, the leading edge of the sheet material 2 does not collide with the rotatable blade 51. In some embodiments, the rotational speed of the outer periphery of the rotatable blade 51 may be increased up to the feedback speed of the sheet material 2 at maximum. In the example as described above, the speed of the outer periphery of the rotatable blade 51 may be increased by about 3 times, i.e., increased from 37 mm/sec to 127 mm/sec.

FIG. 5 is a side elevational view showing an exemplary configuration of the sheet material cutting unit 5 shown in FIG. 1. As shown in FIG. 5, the rotatable blade 51 includes a rotary shaft 51a, both ends of which are rotatably mounted to a support frame 50. A blade member 51b, which is used in cutting the sheet material 2, is connected to the rotary shaft 51a. Further, the rotary shaft 51a includes flat portions 51c formed on the outer periphery thereof such that about half of the outer periphery of the rotary shaft 51a defines an arc with an exterior angle of approximately 190°. The flat portion 51c is formed to allow a leading edge of the printed sheet material 2 (being fed from the right side of FIG. 5) to be inserted between the rotatable blade 51 and the fixed blade 52. In other words, without the flat portion 51c, the leading edge of the printed sheet material 2 may abut against the outer periphery of the rotary shaft 51a, so that the sheet material 2 is impeded from being inserted between the rotatable blade 51 and the fixed blade 52. Therefore, the formation of the flat portion 51c allows the leading edge of the printed sheet material 2 to move along the outer periphery of the flat portion 51c, thereby allowing the sheet material 2 to be stably inserted between the rotatable blade 51 and the fixed blade 52.

FIG. 6 is a perspective view of the rotatable blade 51 of the sheet material cutting unit 5 shown in FIG. 5. As shown in FIG. 6, the rotatable blade Si includes the blade member 51b extending from one end P of the rotary shaft 51a to the other end Q thereof. The blade member 51b defines a predetermined angle with respect to an axial direction of the rotary shaft 51a. The fixed blade 52 is disposed facing the rotatable blade 51 within the support frame 5. With the rotation of the rotatable blade 51 in the direction of an arrow X, the fixed blade 52 is configured to cut the sheet material 2, which is being fed in a direction perpendicular to the axial direction of the rotatable blade 51, in a transverse direction perpendicular to the feed direction of the sheet material 2.

In the above configuration, one end of the sheet material 2 wound in a roll is inserted into the main body of the thermal printer 1 from the sheet material supply unit 3. One surface of the sheet material 2 is printed with given characters, graphics or the like in the print unit 4 within the main body of the thermal printer 1. The printed sheet material 2 is conveyed to the sheet material cutting unit 5. At this time, the rotatable blade 51 is in a state where the flat portion 51c formed on the rotary shaft 51a is directed downward. The leading edge of the printed sheet material 2 is conveyed to the left side of FIG. 5 along the flat portion 51c, and is discharged through the outlet 6 formed on the front upper portion of the main body of the thermal printer 1.

When a sensor (not shown) determines that a leading edge of the printed sheet material 2 is conveyed by a predetermined distance, the sheet material cutting unit 5 cuts the sheet material 2 in the transverse direction perpendicular to the feed direction of the sheet material 2, without stopping the conveyance of the sheet material 2. The leading edge of the printed sheet material 2 is discharged out of the outlet 6 when it is cut to a desired length.

The above-described cutting operation is performed by rotating the rotatable blade 51 in the direction of an arrow X as shown in FIG. 5. That is, the rotation of the rotatable blade 51 in the direction X allows the sheet material 2 (placed between the rotatable blade 51 and the fixed blade 52) to be cut by engagement of the blade member 51b with the fixed blade 52 at a position starting from one end P of the rotary shaft 51a shown in FIG. 6. As the point of engagement of the blade member 51b with the fixed blade 52 continuously progresses toward the other end Q by rotation of the rotatable blade 51, the cut portion of the sheet material 2 also moves in the same direction as the progress direction of the engagement. Then, as the point of the engagement of the blade member 51b with the fixed blade 52 reaches the other end Q of the rotary shaft 51, the cutting operation is terminated. This sheet cutting operation allows the sheet material 2 to be cut in the transverse direction perpendicular to the feed direction of the sheet material 2.

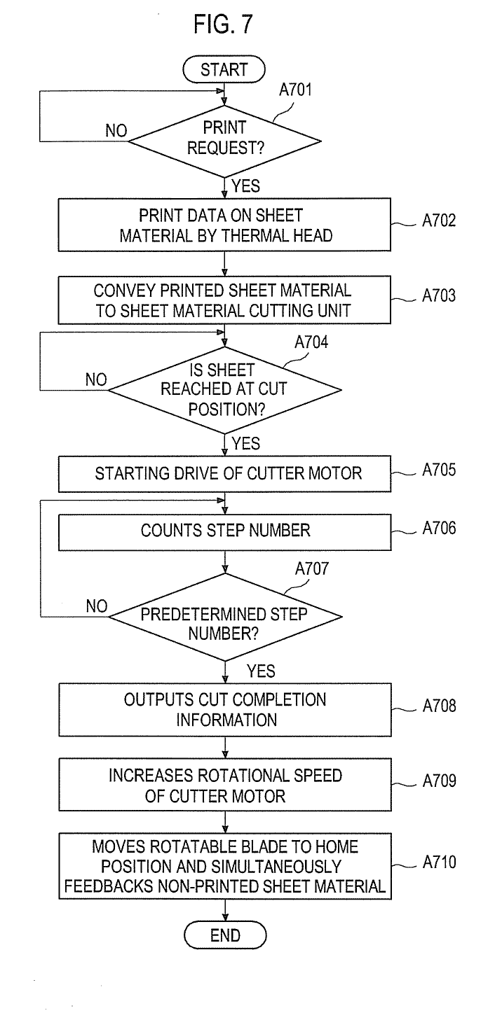

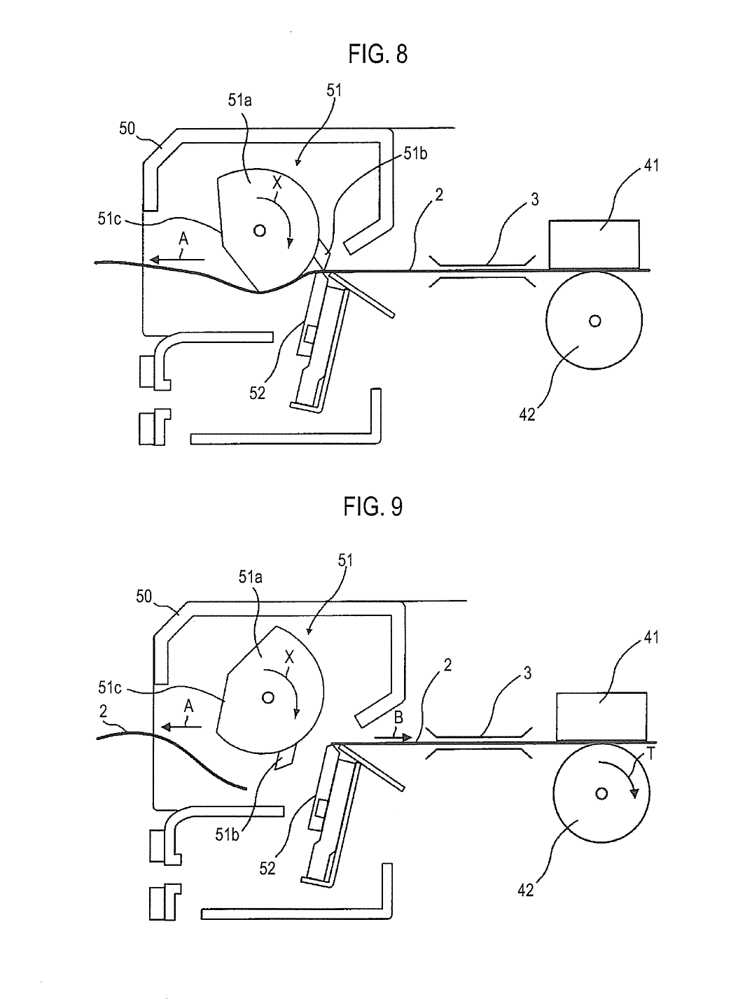

In the following, a detailed description will be made as to the operation of the thermal printer 1 with the aforementioned configuration, with reference to FIGS. 7 to 10. FIG. 7 is a flowchart explaining an example of a sheet material cutting process performed in the thermal printer 1 according to an illustrative embodiment. FIGS. 8 to 10 illustrate a sequence of the sheet material cutting process in the thermal printer 1. It is assumed that the blade member 51b of the sheet material cutting unit 5 is initially positioned at the home position as shown in FIG 5.

In Act A701, the control unit 101 determines whether a print request is received from a higher-level device (not shown) connected thereto through the communication I/F unit 102. If the determination result is YES in Act A701, the process progresses to perform Act A702. On the other hand, if the determination result is NO in Act A701, the process enters a standby mode until the print request is received.

In Act A702, the control unit 101 outputs print instruction and print data to the print processing unit 103. In response to the print instruction, the print processing unit 103 controls the thermal head 41 to print the print data on the sheet material 2.

In Act A703, the control unit 101 outputs a conveyance instruction to the sheet material conveyance processing unit 104. In response to the conveyance instruction, the sheet material conveyance processing unit 104 drives the conveyance mechanism to convey the printed sheet material 2 into the sheet material cutting unit 5.

In Act A704, the sheet material conveyance processing unit 104 determines whether the sheet material 2 is located at a predetermined cut position, based on a detection signal provided from a sensor (not shown) configured to detect a position of the sheet material 2. If the determination result is YES in Act A704, the process progresses to perform Act A705. On the other hand, if the determination result is NO in Act A704, the process enters a standby mode until the sheet material 2 reaches the predetermined cut position.

In act A705, when the sheet material conveyance processing unit 104 stops the driving of the conveyance mechanism, the control unit 101 outputs a drive instruction to the cutter motor drive processing unit 105. In response to the drive instruction, the cutter motor drive processing unit 105 drives the cutter motor.

In Act A706, the step number counting unit 106 receives cutter motor driving information from the cutter motor drive processing unit 105, and performs in real time a counting of a step number representing a rotational angle of the rotatable blade 51 from the beginning of the driving of the cutter motor. The counted step number is output to the cut state determining unit 107.

In Act A707, the cut state determining unit 107 determines whether the counted step number reaches a predetermined step number based on the predefined cut state/step number correlation information 109, wherein the predetermined step number represents that the blade member 51b of the rotatable blade 51 is located at a cut completion position, FIG. 8 shows a state immediately before the sheet material 2 is cut, while FIG. 9 shows a state immediately after the sheet material 2 is cut. In one embodiment, information associated with respective step numbers corresponding to positions (e.g., positions shown in FIGS. 8 and 9) of the blade member 51b of the rotatable blade 51 may be previously stored in, for example, the ROM 12 as the predefined cut state /step number correlation information 109. As such, the cut state determining unit 107 can determine various cut states of the sheet material 2 based on the counted step number provided from the step number counting unit 106. In Act A707, if the cut state determining unit 107 determines that the counted step number reaches the predetermined step number, the process progresses to perform Act A708. Otherwise, the process returns to Act A706, where the same operation as described above is repeated until the condition of Act A706 is satisfied.

In Act A708, if the cut state determining unit 107 determines that the blade member 51b of the rotatable blade 51 is located at the cut completion position, the cut state determining unit 107 generates cut completion information and outputs the same to the control unit 101.

In Act A709, the control unit 101 outputs a new drive instruction to the cutter motor drive processing unit 105. In response to the new drive instruction, the cutter motor drive processing unit 105 increases the rotational speed of the cutter motor.

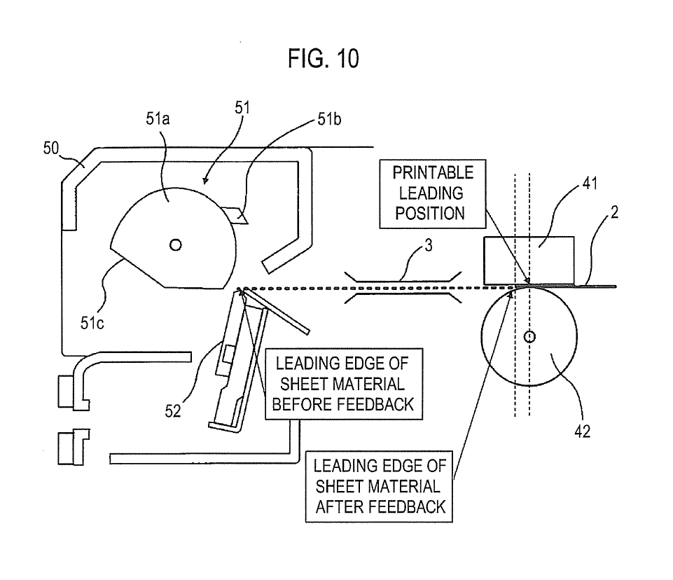

In Act A710, the cutter motor drive processing unit 105 rotates the cutter motor to move the rotatable blade 51 to the home position. Simultaneously, the control unit 101 outputs a conveyance instruction to the sheet material conveyance processing unit 104. In response to the conveyance instruction, the sheet material conveyance processing unit 104 drives a conveyance motor (not shown) of the sheet material supplying unit 3 so that a leading edge of non-printed sheet material 2 is fed back to the thermal head 41. FIG. 10 shows a state in which the blade member 51b of the rotatable blade 51 is returned to the home position, and the sheet material 2 is completely fed back. As shown in FIG. 10, a leading edge of the non-printed sheet material 2 is fed back from the tip of the fixed blade 52 toward the thermal head 41 so that the leading edge of the non-printed sheet material 2 is conveyed to reach a position where a print mechanism provided in the thermal head 41 is disposed. In some embodiments, a rotational direction in which the rotatable blade 51 returns to the home position may be changed according to a design requirement.

Accordingly, in accordance with the sheet material cutting process of the above embodiment, immediately after the sheet material 2 is cut, the rotational speed of the blade member 51b is increased so that the blade member 51b quickly returns to the home position while the sheet material 2 is fed back. This arrangement saves a sheet material cutting time.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus, and can be installed in the apparatus from a computer readable storage medium storing the program therein. A form of the computer readable storage medium can be any form as long as the computer readable storage medium can store programs and is readable by the apparatus, such as a disk type ROM and a solid-state computer storage media. The functions obtained by installation or download in advance in this way can be realized in cooperation with an OS (Operating System) in the apparatus.

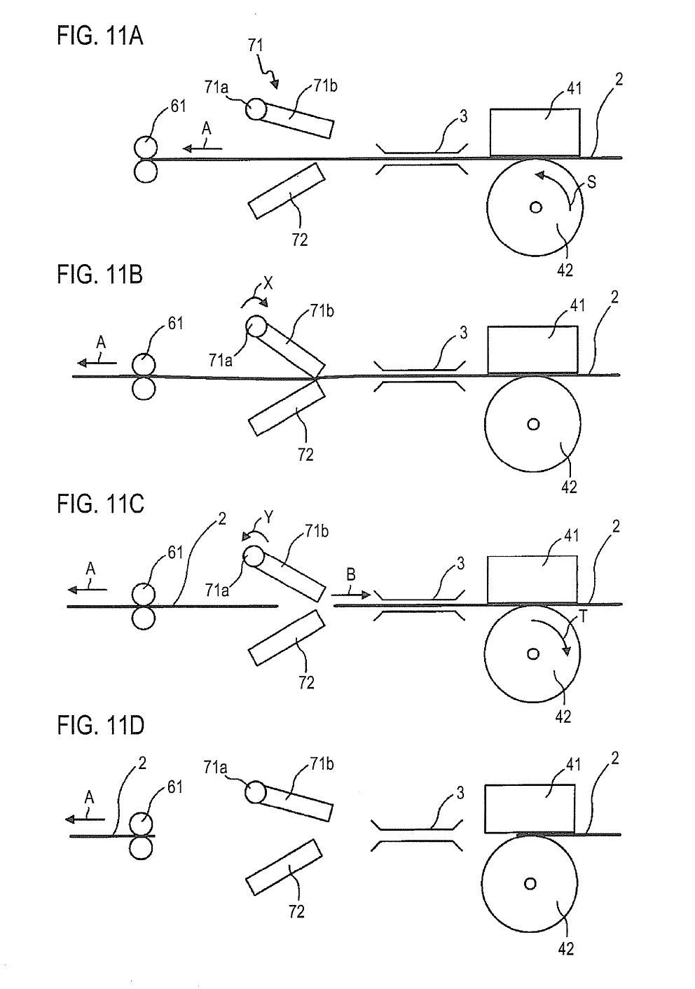

FIGS. 11A to 11D illustrate a sequence of a sheet material cutting process in the thermal printer 1 according to an alternative embodiment. In the following, the same reference numerals as used in the above embodiment refers to the same elements, and thus, a description thereof will be omitted to avoid duplication herein. Only elements of the embodiment shown in FIG. 11 different from those of the above embodiment will be described in details.

While, in the aforementioned embodiment, the cutting blade (e.g., the rotatable blade 51) of the sheet material cutting unit 5 is formed in a rotary type, it may not be limited thereto. For example, the cutting blade of the sheet material cutting unit 5 may be implemented in a swing type. In such a configuration, the cutting state determining unit 107 determines whether the sheet material 2 is completely cut, based on a counted step number provided from the step number counting unit 106 with reference to the predefined cut state/step number correlation information 109. Then, the cutting state determining unit 107 outputs the determination result to the control unit 101.

FIG. 11A shows a state in which the sheet material 2 is being conveyed in the direction of an arrow A prior to the cutting of the sheet material 2. Initially, as shown in FIG. 11A, a blade member 71b of a rotatable blade 71 is positioned at a home position. Further, a platen roller 42 rotates in the direction of an arrow S (as shown in FIG. 11A) so that the sheet material 2 interposed between the platen roller 42 and the thermal head 41 is conveyed in the direction A. Subsequently, the sheet material 2 provided through the sheet material supplying unit 3 passes between a fixed blade 72 and the blade member 71b of the rotatable blade 71 in the sheet material cutting unit 5 and then is discharged to the outside from the outlet 6 by rotation of a pair of discharging platen rollers 61. The pair of discharging platen rollers 61 are provided downstream of the rotatable blade 71 in a paper feed direction (i.e., the direction A) and configured to hold the sheet material 2 interposed between the discharging platen rollers 61.

FIG. 11B shows a state immediately before the sheet material 2 is cut by the sheet cutting unit 5. As shown in FIG. 11B, the blade member 71b of the rotatable blade 71 rotates in a direction of an arrow X (e.g., a direction toward the fixed blade 72) around a rotary shaft 71a so that the sheet material 2 is gripped by the blade member 71b and the fixed blade 72. In this arrangement, the pair of discharging platen rollers 61 rotate in the paper feed direction A (in the manner as described above) to pull the sheet material 2 held therebetween so that a tension is applied to the sheet material 2. In one embodiment, a timing at which the tension is applied to the sheet material 2 may coincide with a timing at which the cutter motor begins to rotate the rotatable blade 71.

FIG. 11C shows a state immediately after the sheet material 2 is cut by the sheet material cutting unit 5. When the cut state determining unit 107 determines (e.g., detects) that the blade member 71b of the rotatable blade 71 is at a cut completion position based on the counted step number provided from the step number counting unit 106, the control unit 101 outputs a drive instruction to the cutter motor drive processing unit 105. In response to the drive instruction, the cutter motor drive processing unit 105 drives the cutter motor to be rotated in a direction in which the sheet material 2 is pulled back from the blade member 71b of the rotatable blade 71 (i.e., a direction of an arrow Y as shown in FIG. 11C). In this case, the rotational speed of the cutter motor in the direction Y is increased to be greater than the rotational speed of the cutter motor in the direction X as shown in FIG. 11B. Similar to the above-described embodiment, the rotational speed of the blade member 71b of the rotatable blade 71 may be increased up to the feedback speed of the sheet material 2. In synchronism with the driving of the cutter motor, the control unit 101 outputs a conveyance instruction to the sheet material conveyance processing unit 104. In response to the conveyance instruction, the sheet material conveyance processing unit 104 rotates the platen roller 42 in a reverse direction of the paper feed direction (e.g., a direction of an arrow T as shown in FIG. 11C), thereby allowing the sheet material 2 to be fed back to the thermal head 41. In some embodiments, the feedback speed of the sheet material 2 may be set to be greater than the rotational speed of the rotatable blade 71 in consideration of printing time after the feedback. This reduces the time required for print-to-cut process.

FIG. 11D shows a state in which the sheet material 2 is fed completely back after the cutting. As shown in FIG. 11D, the blade member 71b of the rotatable blade 71 is returned to the home position, and the sheet material 2 is fed back to the thermal head 41 so that a new leading edge thereof is conveyed to reach a position where the print mechanism provided in the thermal head 41 is disposed.

While in the above embodiments, the rotatable blade 71 (or the rotatable blade 51) has been shown to be located above the sheet material 2, in some embodiments the rotatable blade 71 (or the rotatable blade 51) may be located below the sheet material 2 and the fixed blade 72 (or the fixed blade 52) may be located above the sheet material 2.

According to the embodiments as described above, the rotatable blade 71 is returned to the home position by rotating in the reverse direction of the paper feed direction in synchronism with the driving of the cutter motor, which prevents the surface of the sheet material 2 from being scratched by the blade member 71b of the rotatable blade 71, thereby reducing paper dust generated by scratch.

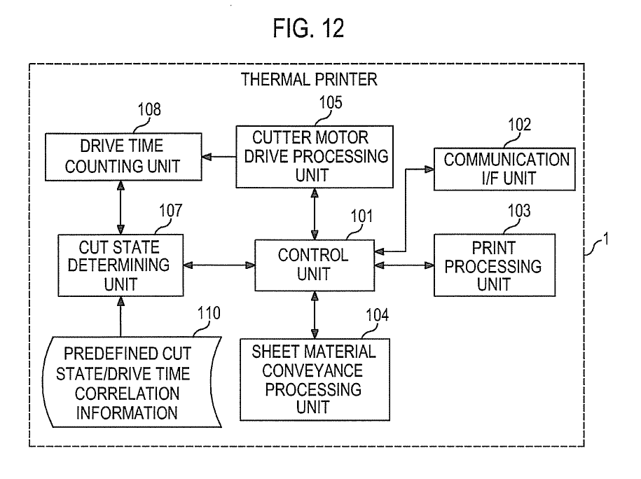

FIG. 12 is a block diagram showing a configuration of a thermal printer according to still another embodiment. The same reference numerals as used in the above embodiments refer to the same elements, and thus, a description thereof will be omitted to avoid duplication herein. Only elements of the embodiment shown in FIG. 12 different from those of the above embodiments will be described in details.

As shown in FIG. 12, the thermal printer 1 according to this embodiment includes a drive time counting unit 108 configured to count a drive time of the cutter motor, in place of the step number counting unit 106 as shown in the above embodiments. In this arrangement, the cut state determining unit 107 compares the drive time provided from the drive time counting unit 108 with a predefined cut state/drive time correlation information 110 to determine whether the sheet material 2 is completely cut. The cut state/drive time correlation information 110 represents a relationship between respective times elapsed after the cutter motor is driven and corresponding cut states at the respective times, which may be previously stored in a storage unit, for example, the ROM 12.

With this arrangement, it is possible to easily determine a cutting state of the sheet material 2 even in a case where the step number information cannot be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer, comprising:
a step number counting device configured to receive drive information associated with a cutter motor, and further configured to count a step number representing a rotational angle of a rotatable blade which is rotated in conjunction with a drive of the cutter motor;
a cut state determining device configured to determine whether a sheet material is completely cut, based on the counted step number provided from the step number counting device, and a predefined cut state/step number that represents a relationship between a position where the sheet material is completely cut by the rotatable blade and a corresponding step number; and
a control device configured to generate a drive instruction to drive the cutter motor when the cut state determining device determines that the sheet material is completely cut,
wherein the rotatable blade is returned to a home position by the drive of the cutter motor at a rotational speed higher than that of the cutting of the sheet material.

2. A printer, comprising:
a control device configured to generate a plurality of instructions to control operation of the printer;
a sheet material conveyance processing device that, in response to a conveyance instruction provided from the control device, is configured to drive a conveyance mechanism and to convey a printed sheet material into a sheet material cutting mechanism;
a cutter motor drive processing device that, in response to a drive instruction provided from the control device, is configured to drive a cutter motor provided in the sheet material cutting mechanism;
a step number counting device configured to receive information associated with the drive of the cutter motor provided from the cutter motor drive processing device, and further configured to count a step number representing a rotational angle of a rotatable blade which is rotated in conjunction with the drive of the cutter motor; and
a cut state determining device configured to determine whether the printed sheet material is completely cut, based on the counted step number provided from the step number counting device, and a predefined cut state/step number correlation information representing a relationship between a position where the printed sheet material is completely cut by the rotatable blade and a corresponding step number; and
wherein, when the determination result obtained at the cut state determining device represents that the sheet material is completely cut, the control device outputs a subsequent drive instruction to the cutter motor drive processing device to drive the cutter motor,
wherein the rotatable blade is returned to a home position by the drive of the cutter motor at a rotational speed higher than that of the cutting of the sheet material.

3. The printer of claim 2, wherein the step number counting device begins to count the step number in synchronism with the drive of the cutter motor.

4. The printer of claim 2, wherein the rotational speed of the rotatable blade is equal to or less than the feedback speed of the sheet material.

5. The printer of claim 2, wherein the control device is configured to output a subsequent conveyance instruction to the sheet conveyance processing device to drive the conveyance mechanism,
wherein the sheet material remaining after the cutting is fed back to a position at which a print head is disposed.

6. The printer of claim 5, wherein the subsequent drive and conveyance instructions are generated from the control device at the same time.

7. The printer of claim 5, wherein the feedback of the sheet material to the print head is performed at a speed greater than the rotational speed of the rotatable blade.

8. The printer of claim 2, wherein the cutter motor rotates in one direction.

9. The printer of claim 2, wherein the cutter motor rotates in two directions.

10. The printer of claim 2, wherein the rotatable blade includes a blade member connected to a rotary shaft, the rotary shaft including a flat portion formed on the outer periphery thereof such that about half of the outer periphery of the rotary shaft defines an arc with a predetermined exterior angle.

11. The printer of claim 10, wherein the predetermined exterior angle is 190°.

12. The printer of claim 10, wherein the blade member extends from one end of the rotary shaft to the other end thereof

13. The printer of claim 12, wherein the blade member defines a predetermined angle with respect to an axial direction of the rotary shaft.

14. The printer of claim 10, wherein the rotatable blade is formed in a swing type.

15. The printer of claim 10, wherein the rotatable blade is formed in a rotary type.

16. A method of controlling a printer, comprising:
upon receiving information associated with driving a cutter motor, counting a step number representing a rotational angle of a rotatable blade which is rotated in conjunction with the drive of the cutter motor;
determining whether a sheet material is completely cut, based on the counted step number and a predefined cut state/step number that represents a relationship between a position where the sheet material is completely cut by the rotatable blade and a corresponding step number; and
generating, when it is determined that the sheet material is completely cut, a drive instruction to drive the cutter motor,
wherein the rotatable blade is driven back by the cutter motor to a home position at a rotational speed higher than that of the cutting of the sheet material.
